(19) United States
(12) Patent Application Publication
(10) Pub. No.: US 2016/0026613 A1
(43) Pub. Date: Jan. 28, 2016

(54) PROCESSING IMAGE TO IDENTIFY OBJECT FOR INSERTION INTO DOCUMENT

(71) Applicant: Microsoft Corporation, Redmond, WA (US)

(72) Inventor: Matthew Vogel, Seattle, WA (US)

(21) Appl. No.: 14/445,030

(22) Filed: Jul. 28, 2014

(51) Int. Cl. G06F 17/24; G06F 3/0481; G06K 9/00; G06F 3/0484

(52) U.S. Cl. CPC G06F 17/24; G06F 17/245; G06F 17/246; G06F 3/0484; G06F 3/04817; G06K 9/00469

(57) ABSTRACT

An image is processed to identify an object for insertion into a document. The image is captured or retrieved from a data store. The image is processed to identify the object associated with a document type, within a portion of the image. The object types include a chart, a table, a shape, among others. The portion of the image is converted into the object. A control is provided to export the object into the document associated with the document type.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render content through a display and enable users to provide input associated with the applications' operations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to processing an image to identify an object for insertion into a document. In some example embodiments, an imaging application may capture an image. The image may be processed to identify an object associated with a document type, within a portion of the image. The portion of the image may be converted into the object. A control may be provided to export the object into the document associated with the document type.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating components of a scheme to process an image to identify an object for insertion into a document, according to embodiments;

FIG. 2 illustrates an example of processing an image to identify a table as an object within the image for insertion into a document, according to embodiments;

FIG. 3 illustrates an example of processing an image to identify a chart as an object within the image for insertion into a document, according to embodiments;

FIG. 4 illustrates an example of processing an image to identify an object within the image for insertion into a document, according to embodiments;

FIG. 5 is a simplified networked environment, where a system according to embodiments may be implemented;

FIG. 6 illustrates a general purpose computing device, which may be configured to process an image to identify an object for insertion into a document; and

FIG. 7 illustrates a logic flow diagram for a process to process an image to identify an object for insertion into a document, according to embodiments.

### DETAILED DESCRIPTION

As briefly described above, an image may be processed to identify an object for insertion into a document by an imaging application. The imaging application may capture an image. The image may be processed to identify an object associated with a document type, within a portion of the image. The portion of the image may be converted into the object. A control may be provided to export the object into the document associated with the document type.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, and a flash drive.

Throughout this specification, the term “platform” may be a combination of software and hardware components to process an image to identify an object for insertion into a document. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

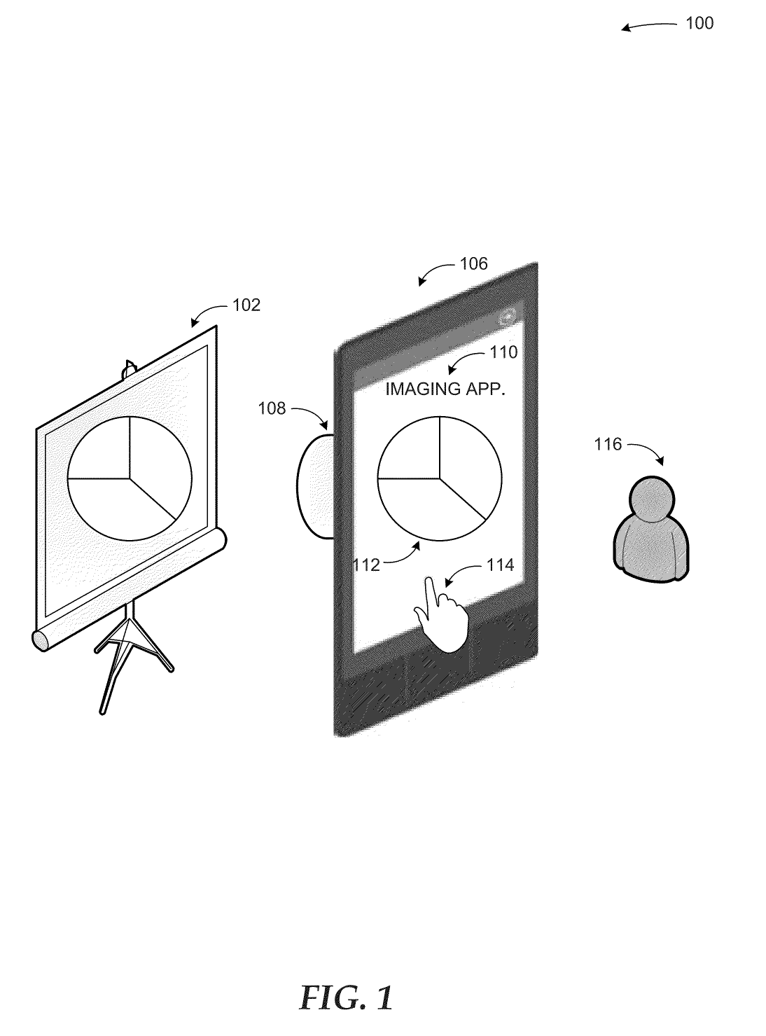

FIG. 1 is a conceptual diagram illustrating components of a scheme to process an image to identify an object for insertion into a document, according to embodiments.

In a diagram 100, an imaging application 110 may capture an image 112 of a screen 102. The screen may display various graphics such as text, shapes, structured text, charts, among others. Alternatively, the imaging application 110 may also capture the image 112 of digital and non-digital surfaces. The graphics may be computer generated or hand written. The imaging application 110 may be executed in a device 106. The device 106 may be a mobile computing device such as a tablet, a notebook computer, a smartphone, among others. The imaging application may capture the image 112 in response to a user action such as a touch based action 114. The image 112 may be captured through a camera component 108 of the device 106. The camera component 108 may include parts such as a lens, an imaging sensor, among others. The imaging application 110 may configure settings such as lighting adjustments, shutter speed, and similar ones to produce an optimum image based on environment settings such as available lighting or user provided settings.

The image 112 may be processed to identify an object within a portion of the image 112. The imaging application 110 may process the image 112. Alternatively, an image identification module may process the image. The image identification module may be a local component of the imaging application 110. Alternatively, the image identification module may be a remote component that has access to unrestricted processing capacity compared to a potential restricted processing capacity available to the imaging application 110 at the device 106.

The portion of the image 112 may be identified as a chart, a table, a shape, and similar object. One or more controls may be provided to export the object to a document of a type associated with the object such a text based document, a spreadsheet document, a presentation document, among similar ones.

The imaging application 110 may provide a user interface (UI) to allow a user 116 to interact with the imaging application 110 through a number of input modalities that may include the touch based action 114, a keyboard based input, a mouse based input, among others. The touch based action 114 may include a number gestures such as touch action, a swipe action, among others.

While the example system in FIG. 1 has been described with specific components including the imaging application 110, the image 112, and the object, embodiments are not limited to these components or system configurations and can be implemented with other system configuration employing fewer or additional components.

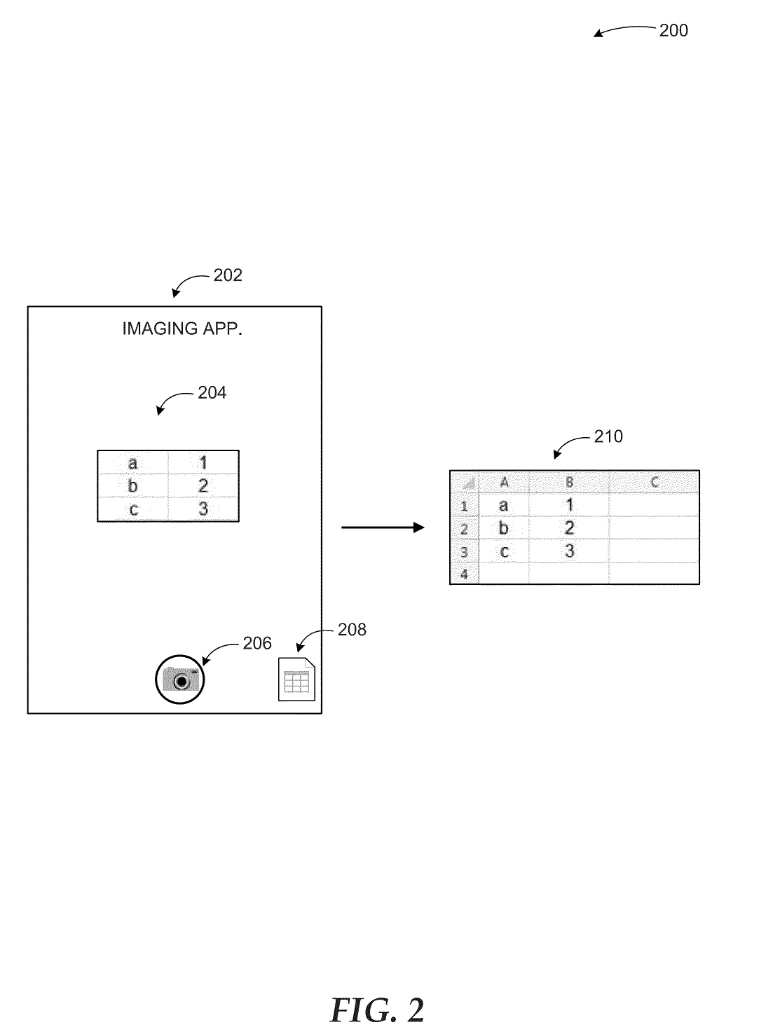

FIG. 2 illustrates an example of processing an image to identify a table as an object within the image for insertion into a document, according to embodiments.

In a diagram 200, an imaging application 202 may process an image 204 to identify a table 210 as an object. The image 204 may be captured in response to a user action on a capture control 206. In response to an activation of the capture control 206, the imaging application may execute operations to capture the image 204 through a camera module of a device associated with the imaging application 202. The captured image 204 may be processed through an image identification module that includes augmented optical character recognition (OCR) capabilities. Text based data such as the table 210 may be identified through the augmented OCR analysis as the object in a tabular format or a table format within a portion of the image 204. The tabular format may include structuring of text based data that may be separated using delimiting characters such a tab character, a line-break character, among others. Table format may include structuring of text based data in cells partitioned by columns and rows. Alternatively, an existing image may be processed through another control in response to a user action or in response to an automated process associated with the imaging application 202. The existing image may be retrieved from a local storage or from a remote storage such as a content provider. The existing image may be processed through the augmented OCR analysis to identify the table 210.

An export control 208 to export the table 210 as the object may be presented with an icon of a spread sheet document. The export control 208 may inform a user interacting with the imaging application 202 that a portion of the image 204 may be identified as the table 210. The icon of the export control 208 may inform the user that the table 210 may be available to export to a document such as spreadsheet document. The imaging application 202 may include an operation in the export control 208 to export the table 210 into a document such as the spreadsheet document in response to an activation of the control.

In an example scenario, the imaging application 202 may generate a chart from the table. The type of the chart and settings of the chart such as title, axis labels may be automatically determined by the imaging application 202 from elements of the table such as a table title, column titles, row titles, and similar ones. Another export control may be provided that includes an operation to export the chart and the table into a document such as a spreadsheet document in response to an activation of the other export control.

In another example scenario, the imaging application 202 may present another export control to export the table 210 as a chart. The imaging application may detect an activation of the other export control. A prompt may be displayed to query a type of the chart to export. The prompt may query the chart title, axis labels, formatting information, among others to capture settings to format the chart. As example of a type of a chart may include a pie chart, a bar chart, a distribution chart, a line chart, an area chart, among others. The user may also be prompted for input about settings for a selection of a chart type. The chart may be generated based on the type of the chart and other settings provided to format the chart. The chart and the table 210 may be exported into a spreadsheet document.

In another example scenario, the imaging application 202 may generate the table 210 from a portion of the image 204 as described above. In addition, a chart may also be identified from another portion of the image 204 or another image. The other portion of the image may be converted to the chart. Relationships between the table 210 and the chart may be detected. The table 210 and the chart may be linked based on the relationships such as correlations between subsets of datasets of the table 210 and the chart. One or more controls may be provided to export the table 210 and the chart into a spreadsheet document.

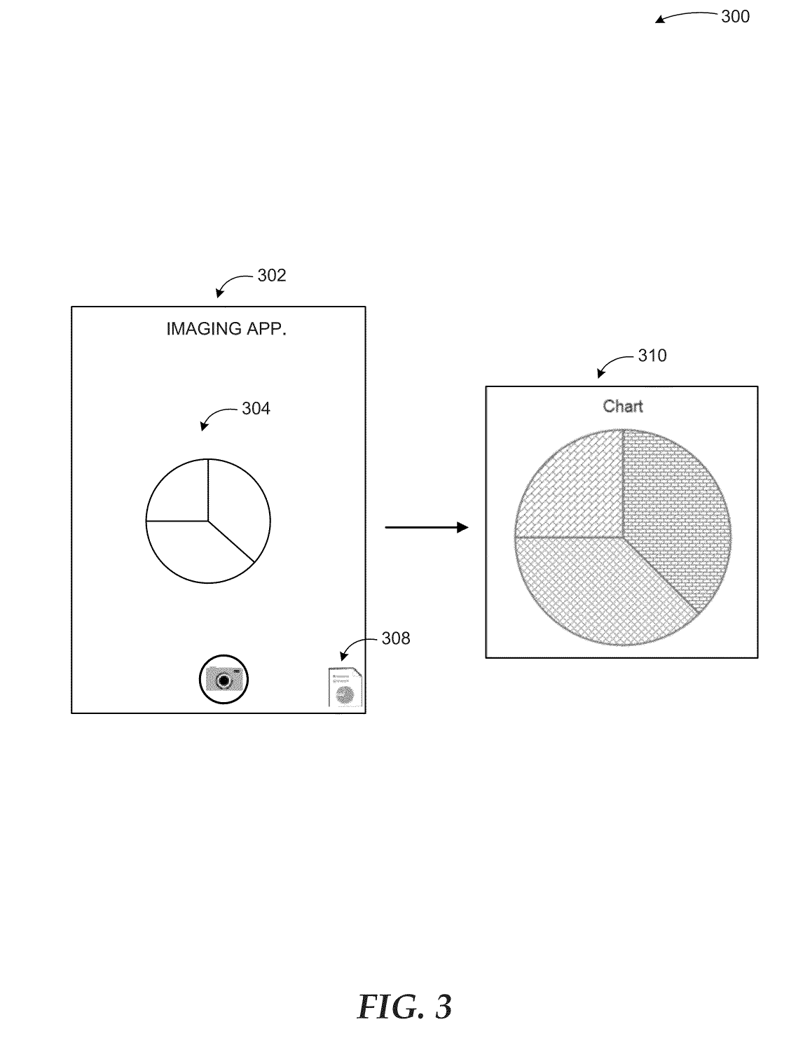

FIG. 3 illustrates an example of processing an image to identify a chart as an object within the image for insertion into a document, according to embodiments.

In a diagram 300, an imaging application 302 may process an image 304 to identify a chart 310 as an object from a portion of the image 304. A type of the chart 310 may be detected by comparing the portion of the image 304 to known chart types such as line chart, pie chart, area chart, bar chart, among others. An export control 308 may be presented with an icon of a document with an embedded graphic associated with the type of the chart. In an example scenario, in response to a detection that the chart type is a pie chart, a pie chart graphic may be embedded into a document icon. The icon may be presented as the export control 308. An operation may be included in the export control 308 to export the chart 310 into a spreadsheet document in response to an activation of the export control 308.

In another example scenario, the chart 310 may be processed to generate a table of values associated with elements of the chart. The imaging application 302 may detect values associated with each element of the chart 310 such as a wedge of a pie chart, an individual bar of a bar chart, among others. The values may be associated with labels from the chart 310. The labels and values may be inserted into a table. An operation may be included in the export control 308 to export the chart 310 and the table into a document such as a spreadsheet document in response to an activation of the control.

The image 304 may also be processed with a set of chart types to match the portion of the image 304 to one or the chart types. The chart type that matches the portion, such as a pie chart, may be used to convert the portion of the image 304 into the chart 310. The chart type may provide configuration information such as placement of elements of the chart, among others to allow the imaging application to convert the portion of the image 304 to the chart 310. The export control 308 may be presented with an icon associated with the chart type. Additionally, an operation may be included in the export control 308 to export the chart 310 into a document, such as a spreadsheet document, in response to an activation of the export control 308.

Although a spreadsheet document was used as an example document type to export objects such as charts and tables identified from images, example scenarios are not limited to the spreadsheet document. Identified objects may also be exported to other document types such as text based documents, presentation documents, among others based on a user configuration or an automated setting.

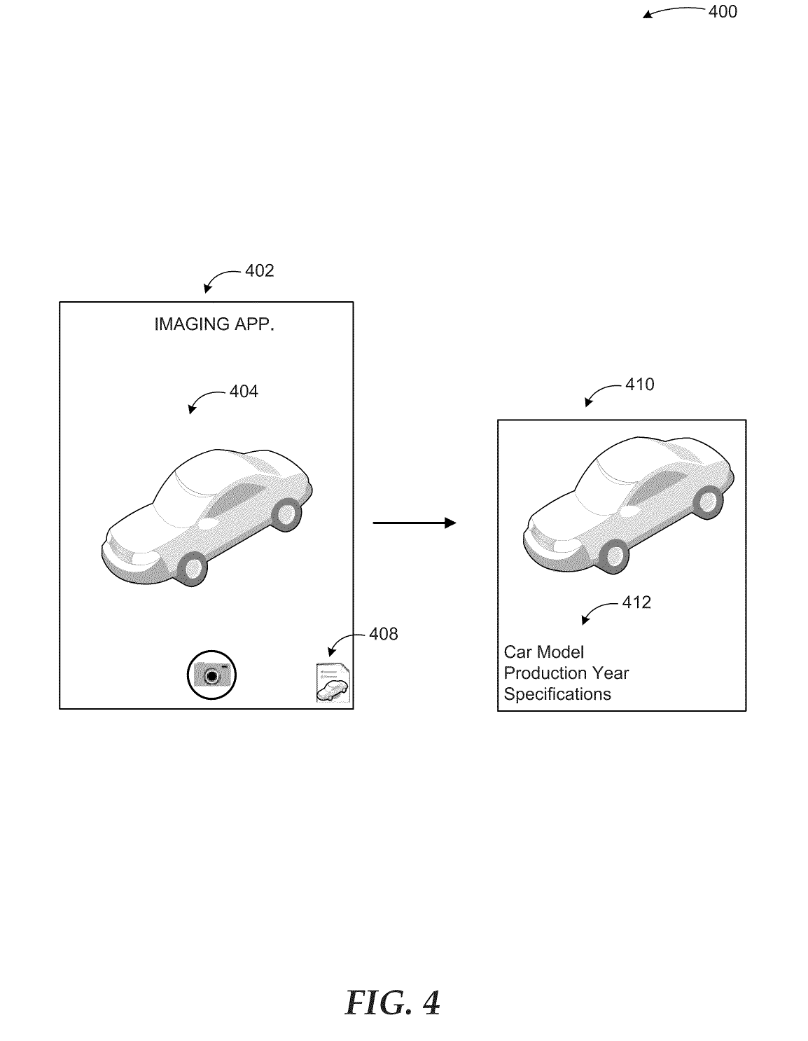

FIG. 4 illustrates an example of processing an image to identify an object within the image for insertion into a document, according to embodiments.

In a diagram 400, an imaging application 402 may process an image 404 with a set of image art to match a portion of the image 404 to one of the image art. In an example scenario, the image 404 may be compared to a set of vehicle image art. After matching the portion of the image 404 to an image art, the portion of the image 404 may be converted into an object 410. Metadata 412 about the image art may be inserted into the object 410 to provide information about the object 410. An example may include providing a set of specifications about a vehicle that is identified as the object 410. Furthermore, an export control 408 may be generated to include an icon with a small graphic of the object 410. The export control 408 may include an operation to export the object 410 to a document in response to an activation of the export control 408.

In another example, a set of shapes may be used to identify the object in the image 404. One of the shapes may be matched to a portion of the image 404. The portion may be converted into the object 410 based on the matched shape. In an example scenario, the portion of the image may be matched to a circle shape. The portion of the image may be converted into the object 410 based on the circle shape acting as a model for the object 410.

Although examples were provided in which an object was identified from an image, example scenarios are not limited to an object identified from an image. Multiple objects of varying types may be identified from an image and exported to multiple documents of varying types.

The technical effect of processing an image to identify an object for insertion into a document may include enhancements in generation of interactive objects with datasets from images in view screen limited environments such as mobile devices.

The example scenarios and schemas in FIG. 2 through 4 are shown with specific components, data types, and configurations. Embodiments are not limited to systems according to these example configurations. Processing an image to identify object for insertion into a document may be implemented in configurations employing fewer or additional components in applications and user interfaces. Furthermore, the example schema and components shown in FIGS. 2 and 4 and their subcomponents may be implemented in a similar manner with other values using the principles described herein.

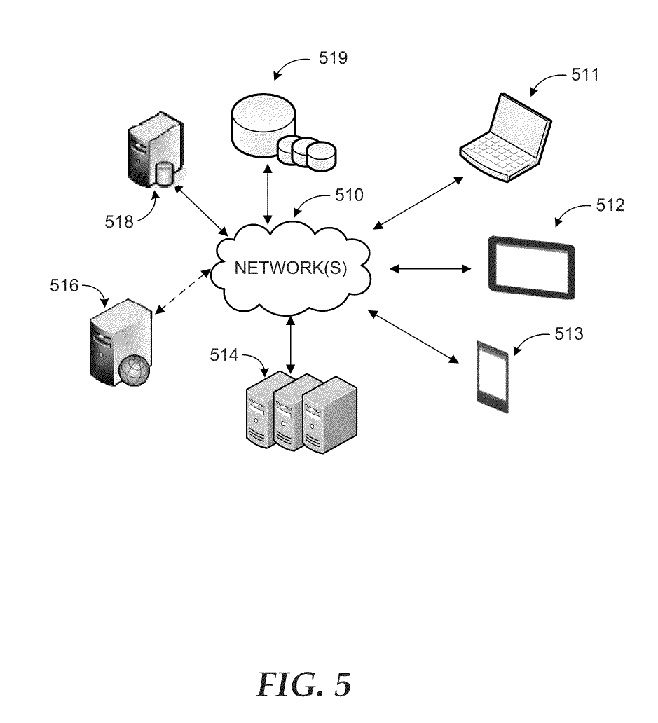

FIG. 5 is an example networked environment, where embodiments may be implemented. An imaging application configured to process an image to identify an object for insertion into a document may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An imaging application may identify an object such as a chart, a table, among others from a portion of an image. The portion may be converted to the object and exported to a document associated with a type of the object. The imaging application may store data associated with the image in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to process an image to identify an object for insertion into a document. Furthermore, the networked environments discussed in FIG. 5 are for illustration purposes only. Embodiments are not limited to the example applications, modules, or processes.

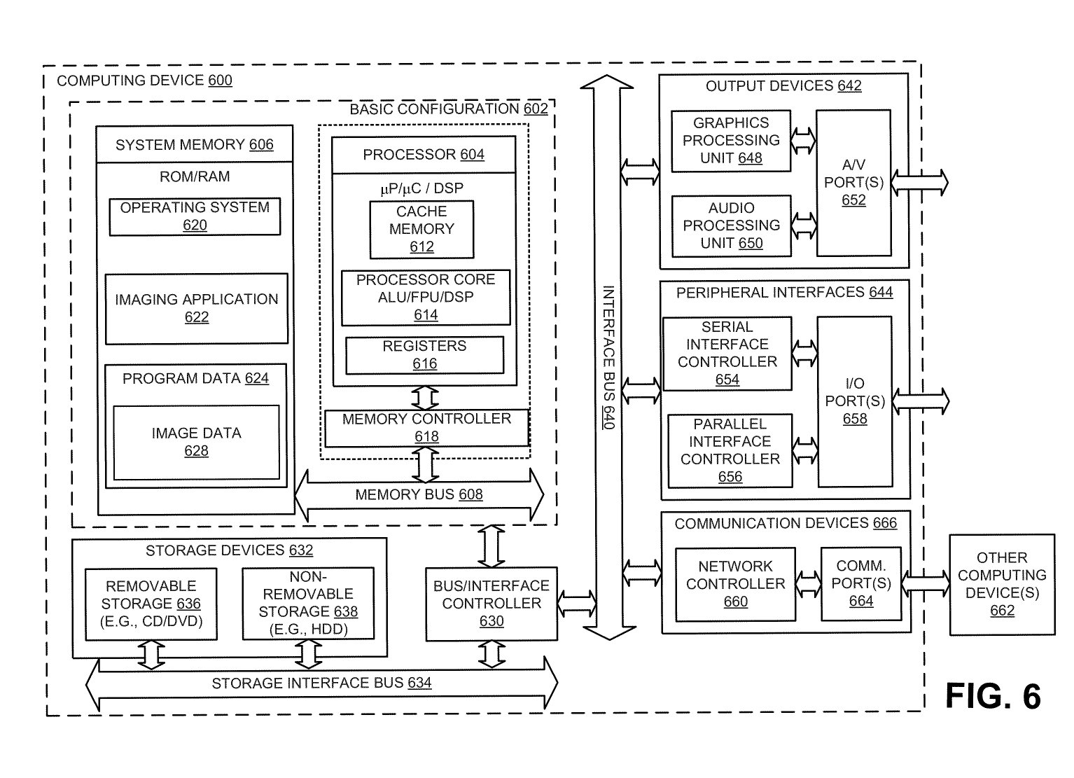

FIG. 6 illustrates a general purpose computing device, which may be configured to process an image to identify an object for insertion into a document, arranged in accordance with at least some embodiments described herein.

For example, the computing device 600 may be used to process an image to identify an object for insertion into a document. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, an imaging application 622, and a program data 624. The imaging application 622 may process an image to identify an object for insertion into a document. The program data 624 may include, among other data, an image data 628, or the like, as described herein. The image data 628 may include an object that may be exported to a document.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include processing an image to identify an object for insertion into a document. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

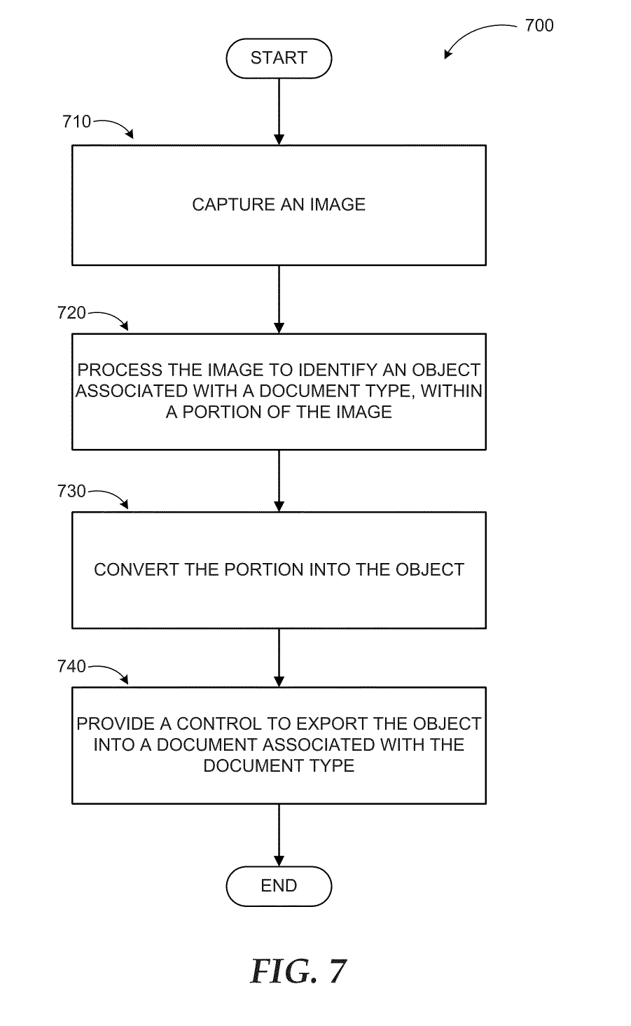

FIG. 7 illustrates a logic flow diagram for a process to process an image to identify an object for insertion into a document, according to embodiments. Process 700 may be implemented on an imaging application.

Process 700 begins with operation 710, where an image may be captured. At operation 720, the image may be processed to identify an object associated with a document type, within a portion of the image. The portion may be converted into the object at operation 730. At operation 740, a control may be provided to export the object into a document associated with the document type.

The operations included in process 700 are for illustration purposes. An imaging application according to embodiments may be implemented by similar processes with fewer or additional steps, as well as in different order of operations using the principles described herein.

According to some examples, a method that is executed on a computing device to process an image to identify an object for insertion into a document may be described. The method may include capturing the image, processing the image to identify the object associated with a document type, within a portion of the image, converting the portion into the object, and providing a control to export the object into the document associated with the document type.

According to other examples, the method may further include processing the image through an image identification module that includes augmented optical character recognition (OCR) to identify text based data as the object in a tabular format within the portion. A table may be identified as the object. The control may be presented with an icon of the document including one from a set of: a spreadsheet document, a text based document, and a presentation document. An operation may be included in the control to export the table into a spreadsheet document as the document in response to an activation of the control. A chart may be generated from the table and another control that includes an operation may be presented to export the chart and the table into a spreadsheet document as the document in response to an activation of the other control.

According to further examples, the method may further include presenting another control to export the table as a chart, detecting an activation of the other control, displaying a prompt to query a type of the chart, receiving an input that includes the type of the chart, generating the chart from the table based on the type of the chart, and exporting the chart and the table into a spreadsheet document as the document. A chart may be identified as the object. A type of the chart may be identified, the control may be presented with an icon of the document with an embedded graphic associated with the type of the chart, and an operation may be included in the control to export the chart into a spreadsheet document as the document in response to an activation of the control. The chart may be processed to generate a table of values associated with elements of the chart and an operation may be included in the control to export the chart and the table into a spreadsheet document as the document in response to an activation of the control.

According to some examples, a computing device to process an image object into an element to insert into a document may be described. The computing device may include a display, a memory, a processor coupled to the memory. The processor may be configured to execute an imaging application in conjunction with instructions stored in the memory. The imaging application may be configured to capture an image, process the image through an image identification module to identify an object associated with a document type within a portion of the image, convert the portion into the object, and provide a control to export the object into the document associated with the document type, on the display.

According to other examples, the imaging application is further configured to capture the image using a camera module in response to a capture action. The image may be processed with augmented optical character recognition (OCR) to identify text based data as the object in a structured format that includes one from a set of: a tabular format, and a table format within the portion.

According to further examples, the imaging application is further configured to process the image with a set of chart types to match the portion to one of the chart types, convert the portion into a chart as the object based on the chart type, present the control with an icon of the chart type, and include an operation in the control to export the chart into a spreadsheet document as the document in response to an activation of the control. The image may be processed with a set of image art to match the portion to one of the image art and convert the portion into the object based on the image art.

According to some examples, a computer-readable memory device with instructions stored thereon to process an image object into an element to insert into a document. The instructions may include actions that are similar to the method described above. The instructions may also include detecting the document type based on the object, where the document type includes one from a set of: a text document, a spreadsheet document, and a presentation document.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to process an image to identify an object for insertion into a document, the method comprising:
capturing the image;
processing the image to identify the object associated with a document type, within a portion of the image;
converting the portion into the object; and
providing a control to export the object into the document associated with the document type.

2. The method of claim 1, further comprising:
processing the image through an image identification module that includes augmented optical character recognition (OCR) to identify text based data as the object in a tabular format within the portion.

3. The method of claim 1, further comprising:
identifying a table as the object.

4. The method of claim 3, further comprising:
presenting the control with an icon of the document including one from a set of: a spreadsheet document, a text based document, and a presentation document.

5. The method of claim 3, further comprising:
including an operation in the control to export the table into a spreadsheet document as the document in response to an activation of the control.

6. The method of claim 3, further comprising:
generating a chart from the table; and
presenting another control that includes an operation to export the chart and the table into a spreadsheet document as the document in response to an activation of the other control.

7. The method of claim 3, further comprising:
presenting another control to export the table as a chart;
detecting an activation of the other control;
displaying a prompt to query a type of the chart; and
receiving an input that includes the type of the chart.

8. The method of claim 7, further comprising:
generating the chart from the table based on the type of the chart; and
exporting the chart and the table into a spreadsheet document as the document.

9. The method of claim 1, further comprising:
identifying a chart as the object.

10. The method of claim 9, further comprising:
detecting a type of the chart;
presenting the control with an icon of the document with an embedded graphic associated with the type of the chart; and
including an operation in the control to export the chart into a spreadsheet document as the document in response to an activation of the control.

11. The method of claim 9, further comprising:
processing the chart to generate a table of values associated with elements of the chart; and
including an operation in the control to export the chart and the table into a spreadsheet document as the document in response to an activation of the control.

12. A computing device to process an image object into an element to insert into a document, the computing device comprising:
a display;
a memory;
a processor coupled to the memory and the display, the processor executing an imaging application in conjunction with instructions stored in the memory, wherein the imaging application is configured to:
capture an image;
process the image through an image identification module to identify an object associated with a document type within a portion of the image;
convert the portion into the object; and
provide a control to export the object into the document associated with the document type, on the display.

13. The computing device of claim 12, wherein the imaging application is further configured to:
capture the image using a camera module in response to a capture action.

14. The computing device of claim 12, wherein the imaging application is further configured to:
process the image with augmented optical character recognition (OCR) to identify text based data as the object in a structured format that includes one from a set of: a tabular format, and a table format within the portion.

15. The computing device of claim 12, wherein the imaging application is further configured to:
process the image with a set of chart types to match the portion to one of the chart types; and
convert the portion into a chart as the object based on the chart type.

16. The computing device of claim 15, wherein the imaging application is further configured to:
present the control with an icon of the chart type; and
include an operation in the control to export the chart into a spreadsheet document as the document in response to an activation of the control.

17. The computing device of claim 12, wherein the imaging application is further configured to:
process the image with a set of image art to match the portion to one of the image art; and
convert the portion into the object based on the image art.

18. A computer-readable memory device with instructions stored thereon to process an image object into an element to insert into a document, the instructions comprising:
capturing an image;
processing the image through an image identification module to identify an object associated with a document type within a portion of the image;
converting the portion into the object based on the document type; and
providing a control to export the object into the document associated with the document type.

19. The computer-readable memory device of claim 18, wherein the instructions further comprise:
detecting the document type based on the object, wherein the document type includes one from a set of: a text based document, a spreadsheet document, and a presentation document.

20. The computer-readable memory device of claim 18, wherein the instructions further comprise:
identifying a table as the object;
presenting another control to export the table as a chart;
detecting an activation of the other control;
displaying a prompt to query a type of the chart;
receiving an input that includes the type of the chart;
converting the table into the chart based on the type; and
exporting the chart and the table into a spreadsheet document as the document.
